(19) United States
(12) Patent Application Publication
(10) Pub. No.: US 2014/0325541 A1
(43) Pub. Date: Oct. 30, 2014

(54) System and Method to Integrate and Connect Friends Viewing Video Programming and Entertainment Services Contemporaneously on Different Televisions and Other Devices

(71) Applicants: Martin Hannes, Washington, DC (US); Arun Mallikarjunan, Silver Spring, MD (US); Tiffany Ann Wood, Washington, DC (US)

(72) Inventors: Martin Hannes, Washington, DC (US); Arun Mallikarjunan, Silver Spring, MD (US); Tiffany Ann Wood, Washington, DC (US)

(21) Appl. No.: 14/069,296

(22) Filed: Oct. 31, 2013

Related U.S. Application Data
(60) Provisional application No. 61/720,586, filed on Oct. 31, 2012.

(51) Int. Cl. H04N 21/63; H04N 21/4788; H04N 21/258; H04N 21/43; H04N 21/61; H04N 21/432; H04N 21/442; H04N 21/482

(52) U.S. Cl. CPC H04N 21/632; H04N 21/44222; H04N 21/4788; H04N 21/482; H04N 21/4302; H04N 21/6125; H04N 21/6175; H04N 21/432; H04N 21/25875
USPC 725/14

(57) ABSTRACT

The present invention relates generally to a system and apparatus for video entertainment. More specifically, the present invention is a system and apparatus to integrate and connect friends viewing video programming and entertainment services contemporaneously on different televisions and other devices.

### CROSS-REFERENCE TO RELATED APPLICATIONS

This application claims the benefit of provisional patent application, U.S. Pat. App. No. 61/720,586 filed on Oct. 31, 2012, which is hereby incorporated by reference in its entirety.

### FIELD OF THE INVENTION

The present invention relates generally to a system and apparatus for video entertainment. More specifically, the present invention is a system and apparatus to integrate and connect friends viewing video programming and entertainment services contemporaneously on different televisions and other devices.

### BACKGROUND OF THE INVENTION

With the ubiquitous nature of social media, television, Internet accessibility, portable computing devices and general remote connectivity between individuals, there is a growing need for individuals to be able to connect while engaging in the same or similar activity.

The growth of social media and interconnectivity has allowed for the retention of networks and relationships beyond those with our local peers, friends and family. As these individuals disperse, whether for jobs, education, travel or other reason, they still retain and maintain their relationships over these social mediums.

While social media platforms allow individuals to keep connected while remote from one another, they lack in the ability to connect users to a shared activity in the present, such as the ability to watch and interact with a television show or streaming media (e.g., movies, audio, live video). So where two or more individuals may be partaking in the same action concurrently (e.g., watching a television program), there is no way for them to interact with one another or be alerted to the fact that their current actions are overlapping with others in their network.

Further, since the rise of interactive content sources and smart displays, such as set top boxes (STBs), smart televisions (smart TVs), home theater personal computers (HTPCs) and other mobile and interconnected computing devices, the ability to have these interactive content sources integrate with traditional computing devices to create networked and programmable sources of interaction has come to a head. Integrating applications to control everything from the display of a smart TV or the programming of a STB is possible, allowing for the possibility of integrating these devices with a larger system to provide concurrent services to individuals connected via the system.

Therefore, there is need in the art for a system and apparatus to integrate and connect friends viewing video programming and entertainment services contemporaneously on different televisions and other devices. These and other features and advantages of the present invention will be explained and will become obvious to one skilled in the art through the summary of the invention that follows.

### SUMMARY OF THE INVENTION

Accordingly, it is an aspect of the present invention to provide a system and apparatus to integrate and connect friends viewing video programming and entertainment services contemporaneously on different televisions and other devices as well as methods related thereto.

With the advent of smart TVs and IP linked television devices there exists the possibility to connect users via these devices to other users who may be viewing contemporaneously. The preferred embodiment of the present invention may be referred to hereinafter as “Connected Friends Viewing system”. Embodiments of the Connected Friends Viewing system (“the system”) described herein leverages advanced cloud based servers to join users who are “Viewing Friends” together as they watch television or other video media. In particular, embodiments of this system leverage lists of “Viewing Friends” to share information and set up joint viewing sessions between two or more parties.

Embodiments of the system allow users to contact and notify their “Viewing Friends” of programs they like and or have scheduled to watch via their television or other linked device (Smartphone, tablet or PC). In this way they can invite other users to join in watching those specified programs at scheduled times.

According to an embodiment of the present invention, the system “knows” what the other individual “Viewing Friends” are watching or have scheduled to watch, users are able to click on a friends icon or scheduled program to allow them to join in watching the same program at their different locations.

The system also provides recommended viewing utilizing artificial intelligence software leveraging not only the viewing habits of the individual, but also that of his friends as well. In this way the user is presented with a much more relevant group of programming options and suggestions rather than just a broad sampling of the community at large (which is not much different to typical television viewing ratings).

The users of the system also have the ability to have open voice communications during programs with one or more of their friends viewing the same program. In this way the system creates what is in effect a joint viewing session—almost as if the other user(s) were in the same room.

According to an embodiment of the present invention, a computer implemented system for integrating and connecting users viewing content on disparate display devices, the system comprising: an application software module, comprising computer-executable code stored in non-volatile memory, a processor, a memory, and a communications means, wherein said application software module, said processor, said memory, and said communications means are operably connected and are configured to: receive a connection request from a first user via said connection means; identify said first user; identify a viewing list associated with said first user, wherein said viewing list comprises a list of one or more multiuser viewing channels attended by one or more secondary users affiliated with said first user; communicate said viewing list to said first user; receive a multiuser channel command from said first user; and process said multiuser channel command, wherein said multiuser channel command effects at least one of said one or more multiuser viewing channels.

According to an embodiment of the present invention, the multiuser channel command is a command to join one of said one or more multiuser viewing channels.

According to an embodiment of the present invention, the application software module, said processor, said memory, and said communications means are further configured to confirm first user has access privileges to said multiuser viewing channel.

According to an embodiment of the present invention, the application software module, said processor, said memory, and said communications means are further configured to transmit to a display element associated with said first user a channel join command, wherein said channel join command allows the display element associated with said first user to join said multiuser viewing channel and view viewing content presented on said multiuser viewing channel.

According to an embodiment of the present invention, the multiuser channel command is a command to switch viewing content.

According to an embodiment of the present invention, the application software module, said processor, said memory, and said communications means are further configured to transmit to a plurality of display elements associated with said first user and one or more of said one or more secondary users a content switch command, wherein said content switch command allows said plurality of display elements to change displayed content.

According to an embodiment of the present invention, the multiuser channel command is a synchronization command, and wherein said application software module, said processor, said memory, and said communications means are further configured to transmit to a plurality of display elements associated with said first user and one or more of said one or more secondary users a synchronization command, wherein said synchronization command effects the synchronization of displayed content across the plurality of display elements such that the content displayed on each element of said plurality of display elements is substantially the same.

According to an embodiment of the present invention, a computer implemented system, said system comprising: an application software module, comprising computer-executable code stored in non-volatile memory, configured to: receive a connection request from a first user via said connection means; identify said first user; identify a viewing list associated with said first user, wherein said viewing list comprises a list of one or more multiuser viewing channels attended by one or more secondary users affiliated with said first user; communicate said viewing list to said first user; receive a multiuser channel command from said first user; and process said multiuser channel command, wherein said multiuser channel command effects at least one of said one or more multiuser viewing channels.

According to an embodiment of the present invention, a computer implemented method for integrating and connecting users viewing content on disparate display devices, the system comprising, the method comprising the steps of: receiving a connection request from a first user; identifying said first user; identifying a viewing list associated with said first user, wherein said viewing list comprises a list of one or more multiuser viewing channels attended by one or more secondary users affiliated with said first user; communicating said viewing list to said first user; receiving a multiuser channel command from said first user; and processing said multiuser channel command, wherein said multiuser channel command effects at least one of said one or more multiuser viewing channels.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 is a diagram of a computing device, in accordance with an embodiment of the present invention;

FIG. 2 is a diagram of a Connected Friends Television and Video Entertainment Viewing system;

FIG. 3 is an alternative diagram of the Connected Friends Television and Video Entertainment Viewing system;

FIG. 4 is a process flow diagram showing an exemplary method in accordance with an embodiment of the present invention; and

FIG. 5 is a process flow diagram showing an exemplary method in accordance with an embodiment of the present invention;

FIG. 6 is a process flow diagram showing an exemplary method in accordance with an embodiment of the present invention.

### DETAIL DESCRIPTIONS OF THE INVENTION

A better understanding of the disclosed embodiments will be obtained from the following detailed descriptions and accompanying illustration. All illustrations of the drawings are for the purpose of describing selected versions of the present invention and are not intended to limit the scope of the present invention.

Embodiments of the present invention are directed to providing a system and apparatus to integrate and connect friends viewing video programming or other entertainment services contemporaneously on different televisions and other devices. The system incorporates a software component, such as an application (“app”) on a display device, such as a television or smart TV or other viewing or controlling device which is linked via an IP network to cloud based servers which link and control the integration of defined “Viewing Friends” in different locations.

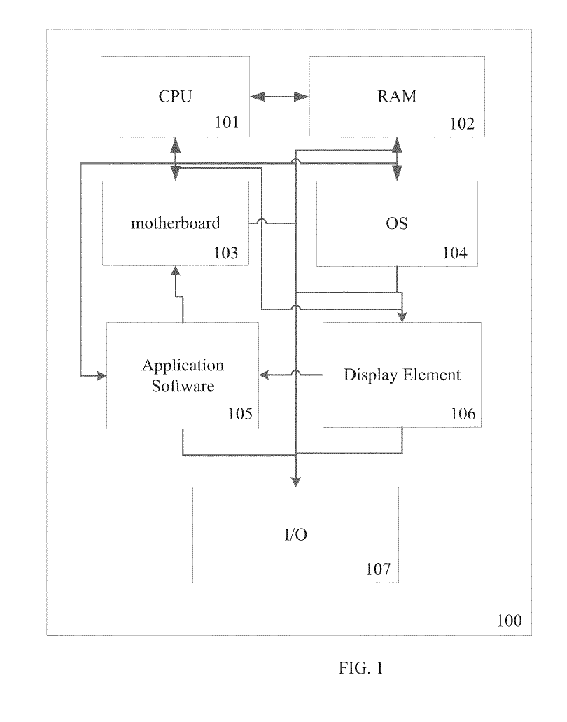

Turning now to FIG. 1, an exemplary embodiment of a display device or other controlling device, in accordance with an embodiment of the present invention, is shown. According to an embodiment of the present invention, the device incorporates one or more of a processing unit 101, motherboard 103 with RAM memory 102 and OS 104 as well as application software 105 for providing functionality and command information, a display element 106 (e.g., color LCD display with touch screen capabilities, IPS display, LED display, retina display), and one or more input/output means 107 (e.g., keyboard, various input/output ports for Ethernet, firewire, USB, HDMI, wireless connection means, IR receiver to interact with a remote control). Examples of display devices and controlling devices include, but are not limited to, smart TVs, STBs, smartphones, tablet PCs, desktop PCs, laptops, HTPCs or any combination thereof. One of ordinary skill in the art would appreciate that there are numerous types of display devices and controlling devices that could be utilized with embodiments of the present invention, and embodiments of the present invention are contemplated for use with any appropriate display device or controlling device.

According to an embodiment of the present invention, once users have set up their personal options, they can access the system, such as via a website or social network sites with linkage to the system, in order to select friends from their current friends lists and invite them to join their “Viewing Friends” group. After this has been done and their friends have accepted the invitation to join a “Viewing Friends” group, the system provides the users the ability to view and share each other's television or other video viewing and partake in joint/connected viewing.

According to an embodiment of the present invention, the system may be configured to provide various options to users, such as via an interactive menu displayed on a display element of a computing device. Options may include, but are not limited to, programming choices based on a location of the user and particular service provider(s) available to the user and preferences of the user as well as suggestions of the friends of the user. To determine what connected users may want to watch, the system may be configured to provide users with the ability to see how many of their friends are watching a particular program (and who there are) as well as checking the program's positive or negative ratings as determined by their exclusive viewing group.

In certain embodiments, if users want to invite “Viewing Friends” to join them to watch a particular program, the system can provide the user the ability to send invitations via an interactive means, such as scheduling page on a website or application or directly via a program guide or Friends List page. Their friends then receive an invitation to watch and a tentative booking is made on that friend's viewing schedule at the designated time. Invitations may be communicated to the friends of the user via one or more electronic communications means, such as via email, direct communication via the system and its applications, SMS message, instant messaging means or any other electronic messaging means.

In certain embodiments, the system may provide users the ability to select options related to the television content or other entertainment media. These options may be used to enhance the viewing experience or otherwise group the Viewing Friends. For instance, when viewing sports programming or contests with Viewing Friends, the system may be configured to request users nominate which team or party they are supporting. In this example, the system may then be configured to display this information on-screen in real time during the event showing the list of friends supporting each team, player or contestant involved. Further, the system could be configured to provide different commentary based on the selection of team chosen by each user (e.g., one call for the home team and a second call for the away team). One of ordinary skill in the art would appreciate that there are numerous options and scenarios by which users could be allowed to select options and have their grouping or other viewing experience varied by the selection, and embodiments of the present invention are contemplated for use with any type of option based variance and grouping of users.

According to an embodiment of the present invention, the system may be configured to support multiple user profiles so that different users in the same location can use the same physical device identified via their user ID. The user profiles feature also allows each user to customize the device's functionality to reflect his or her personal interests. When multiple user IDs are utilized on a single computing device, the system may be configured to limit certain features or customizations so that no conflict between configurations occur. For instance, if users are watching a sports game where the users support different teams, the system could be configured to utilize a specific audio selection based on a selected team call. This could be selected, for instance, via a vote (majority wins) or via one or more users with administrative privileges (owner of the device). One of ordinary skill in the art would appreciate that there are numerous methods for selecting options and limiting customizations, and embodiments of the present invention are contemplated for use with any such method.

According to an embodiment of the present invention, an artificial intelligence logic may be integrated into the components of the system and can be utilized to automatically make viewing changes (change viewing channels on the television or other device) and or viewing recommendations as required, based on preferences, viewing history, friends viewing and or friend's recommendations as well as location and time of day or day of week and local weather conditions. For instance, an artificial intelligence logic component may be engaged when a threshold number of a user's friends are viewing a particular show/channel that the user is not currently watching. The artificial intelligence logic component may provide an update of this occurrence to the user via a display element of one or more computing devices operated by the user. This may also include an interactive element (e.g., Uniform Resource Locator (URL), interactive icon in an application) allowing the user to have his/her viewing device (e.g., smart TV, STB) automatically change to the show/channel viewed by the user's friends.

In addition to the television or smart TV, other computing devices (e.g., Smartphones, tablets and PC's) can be linked to the system and share some or all of the joint functionality (such as program selection, friends viewing and suggestions and scheduling) as well as the other communications features. In certain embodiments, where multiple users are watching a shared display element (e.g., smart TV) in the same location, computing devices may be linked with the system and identify that they are all watching the same display in order to provide a multiuser experience on a shared display. In this setup, the shared display element may be configured to receive updates from the system based on all users identified and associated with the shared display element. It should also be noted that the shared display element may be comprised of more than one display element (e.g., multiple smart TVs, multiple monitors).

According to an embodiment of the present invention, the system may include connections to one or more televisions, smart TVs, STBs or other connected device with the prescribed app installed. These devices are then linked to the internet via Ethernet, WiFi or other connection and to the system servers in the cloud.

In a preferred embodiment, the system is comprised of one or more cloud based servers configured to manage all aspects of the service including the control of the device(s) to modify and change outputs (i.e. change channels), establishing and running the communications links between the various users and the control and management of all the data associated with users and “Viewing Friends”, real-time program guides and program information and any other related information such as history of usage which is required for the predictive viewing algorithms. In this embodiment, the system is configured to connect to various devices, generally through installation or integration of an application or other module in or on a computing device, display component or other device.

In a preferred embodiment of the present invention, users will initially register for the service via entry screens on his/her television, PC or other device, and is then authenticated by the system. Subsequently, users are presented with a dashboard and menu of options from the system which allows him/her to check and select programming, schedule viewing, invite friends to view with him/her, commence a joint viewing session, check what his/her friends are watching and their recommendations and communicate via voice or test messaging with other “Viewing Friends” on any of their devices including the television.

When the user is viewing programming the application will be active in the background on the television or on second screen devices until the user requests information from the system or a “Viewing Friend” sends an invite, request or other message. In this case the screen will display a notification which the user can interact with to see that information. Interaction with the notification may be by any method allowed by the device (e.g., mouse click, remote control usage, touchscreen). One of ordinary skill in the art would appreciate that there are numerous methods for interacting with devices and embodiments of the present invention are contemplated for use with any method for interacting with devices.

If the user has scheduled to view particular programs at a specific time, the system may be configured to automatically change channel to that program at that time. Further, if this is part of a joint viewing event with friends, the Viewing Friends devices will be linked and voice and communications channels opened to allow communications between these users as required. Communications between users may be through audio, video, text or any combination thereof. One of ordinary skill in the art would appreciate that there are numerous types of communications that could be utilized with embodiments of the present invention and embodiments of the present invention are contemplated for use with any type of communications. Further, the system may allow for the selection of communication types by the user (e.g., text only, text and audio—no video).

In a preferred embodiment, the system may be configured to allow users to see what their friends are viewing. This may include what their friends are presently viewing (e.g., channel, content title, provider), what their friends have watched in the past or what their friends are going to watch in the future. In this manner, the system allows users to instantly connect with their friends or plan to connect with their friends in the future based on content viewing plans (e.g., content calendaring). Further, the system may be configured to schedule and/or automatically open a multiuser viewing channel when the content the user(s) wish to watch is active.

In certain embodiments, the system may be configured to allow a user to scan through the various viewing content their friends are currently viewing. In this embodiment, the system may be configured to change the viewing content on the user's display element to that of their friends for a brief interval (e.g., 5 seconds, 10 seconds, 20 seconds, 1 minute) and continue to switch through the various viewing content their friends are currently viewing until the user takes some action to stop the scan. Alternatively, the scan could end after one full pass through the user's friends. In other embodiments, the scan could end on other events that would be understood by those of ordinary skill in the art. Further, the brief interval for viewing content could be any interval, and embodiments of the present invention are contemplated for use with any interval.

In certain embodiments, the system may be configured to allow for the user to see what their friends are watching through third party social media or other networked or web based systems. For instance, the system may integrate with such third party systems via an application or via an integration into the third party system (e.g., Facebook® integration, Google+® integration). In this manner, even when the user is not directly connected to the system, the user may be able to identify what their friends are watching and determine if they want to connect to the system in order to start multiuser viewing with their friends via a multiuser viewing channel.

In certain embodiments, the system may be configured to provide cross network or cross platform content identification to users. For instance, if a first user is on a first TV provider source and a second user is on a second TV provider source, the system is configured to and capable of providing the appropriate channel conversion for each friend so that they can watch the same content on the disparate TV provider sources. This also applies to content sources other than TV. For instance, if one premium streaming service provides a content to a first user and the same content is being provided to a second user via a second premium streaming service, the system may identify the content and match content viewing amongst the users. This can be achieved by matching content selections via one or more identifiers (e.g., channel guide, content guide, file name). One of ordinary skill in the art would appreciate that there are numerous methods for matching content selections between providers and embodiments of the present invention are contemplated for use with any appropriate method.

In certain embodiments, where a first user has access to a first content, but a second user does not have access to the first content, the system may be configured to prompt the second user on how to obtain access to the first content. For instance, if a first user was watching a premium cable channel and the second user did not subscribe to that premium cable channel, the system may be configured to identify how the second user can gain access to the premium cable channel, including by way of offering immediate access (e.g., through payment of a fee or acceptance of a terms of service). This is specifically useful where multiple users are switching amongst content and one or more users does not have access to that particular content. The system can then assist those excluded users in obtaining access to the content so that they can continue their multiuser viewing experience.

In certain embodiments, the system may allow for users to rate shows or show support for teams while watching particular programming. The system is configured to synchronize this information across one or more linked devices of the users so that each user has access to the selections made by the other users in their Viewing Friends. In a preferred embodiment, the rating could be binary, such as like/dislike. In other embodiments, rating could be on any numeric or other scale. One of ordinary skill in the art would appreciate that there are numerous rating scales that could be utilized with embodiments of the present invention, and embodiments of the present invention are contemplated for use with any appropriate rating scale.

Separately, based on the choice of channel (program) on a linked television, the system may be configured to automatically provide background information on a program displayed or to be displayed on the television or other second screen device as required. This will also include information on which of the user's friends are watching, their ratings and program specific comments from these Viewing Friends.

As the system is used over time, history of personal usage, friend's usage and friends preferences are analyzed to develop user specific profiles which then are utilized to make predictive suggestions and recommendations for programming content. The system provides the option of a personalized program guide which reflects this information presenting only channels or shows which are likely to be interesting to the viewing user. For example, on a particular Saturday afternoon, a user's personalized guide would only show those sports and news program which the system knows that you and your friends TV watch—for instance college football and sports highlights. The preferences and recommended viewing are, therefore, also associated with time of day, day of week, and parameters such as local events and weather conditions to develop more accurate recommendations for the individual's viewing.

Given the system has detailed knowledge of an individual's viewing habits and those of his/her friends, the system can also push targeted advertising to individual users or particular Viewing Friends groups. This can be in the form of banners, tickers, notifications or traditional video clips, which can also be interactive.

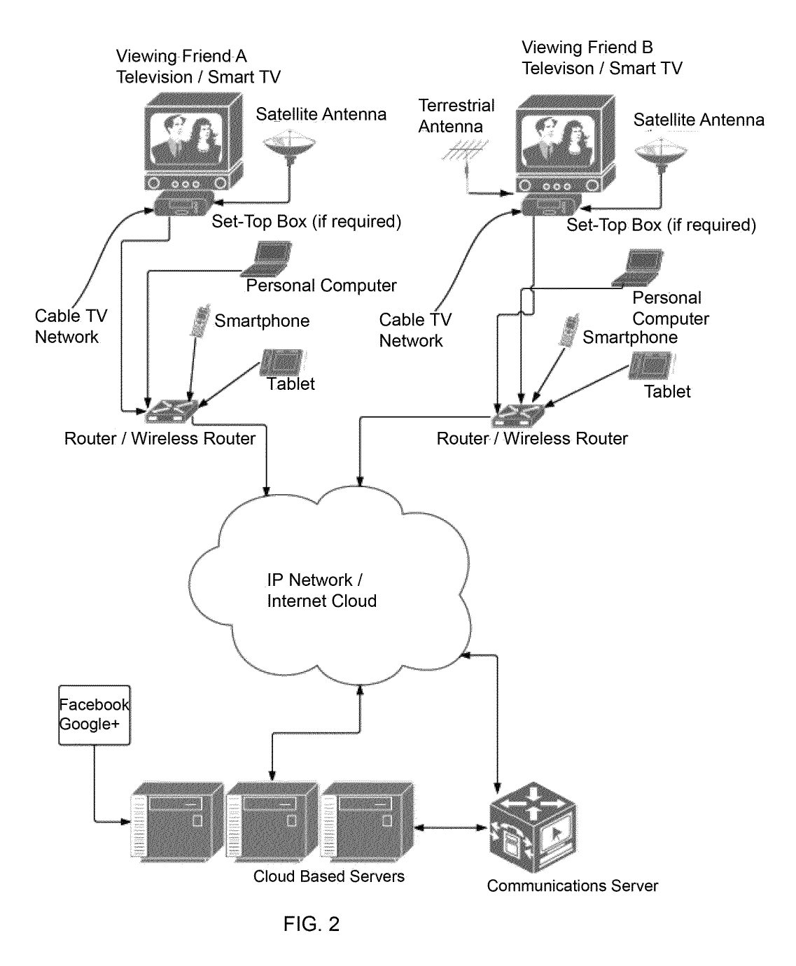

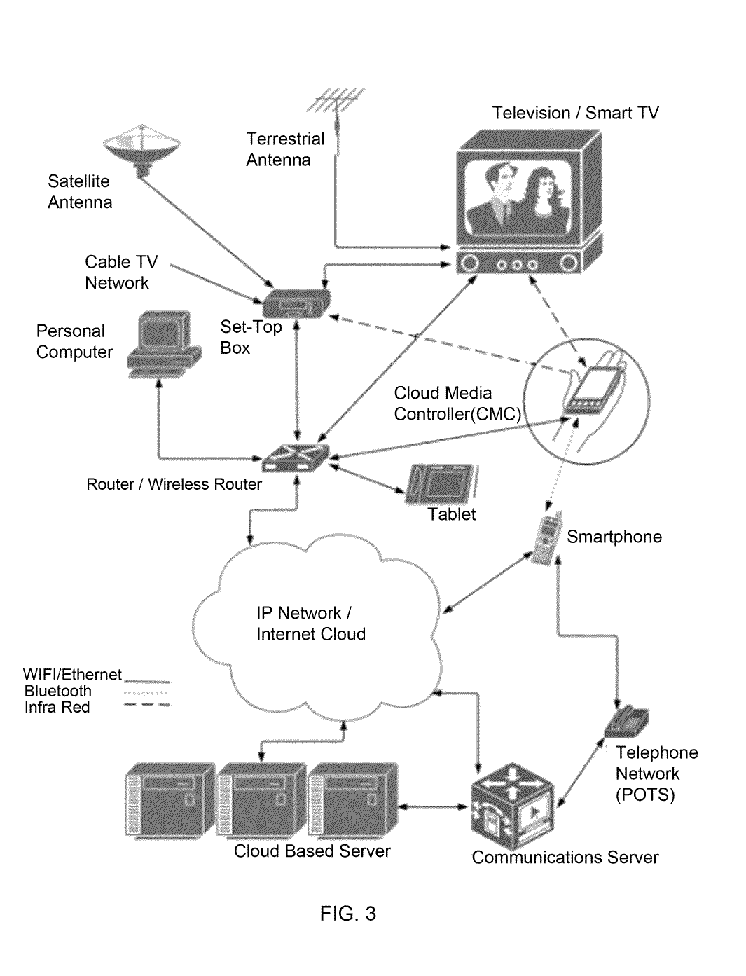

Turning now to FIGS. 2-3, embodiments of the present invention are shown. This embodiments includes key elements of the system and cloud based servers including: (I) Connected Devices and Software Apps, such as, but not limited to: a) television with internet connectivity or Smart TV with system applications running and connected to the internet; b) other second screen devices including smartphones, tablets and PC's likewise with system applications running and connected to the internet via Ethernet, WiFi, cellular (e.g., CDMA, GSM), Bluetooth or other connection means or combination thereof; c) device application software to control and up-date functionality on each device; and d) WiFi/Ethernet/Bluetooth network interfaces to Internet and cloud based servers; and (II) Cloud Network system and Software Applications, including, but not limited to: a) user web portal and interface for account administration and setting of user parameters; b) cloud based servers with integration systems for the various linked devices; c) database system for storage of user and friends viewing and preference information and history; d) artificial intelligence software systems for predictive programming recommendations; e) communications servers and software to enable voice, text and other messaging between users; and f) Direct links to social networking sites. One of ordinary skill in the art would appreciate that the system could be comprised of fewer components or additional components than those displayed in FIG. 2 and FIG. 3 is provided for exemplary purposes.

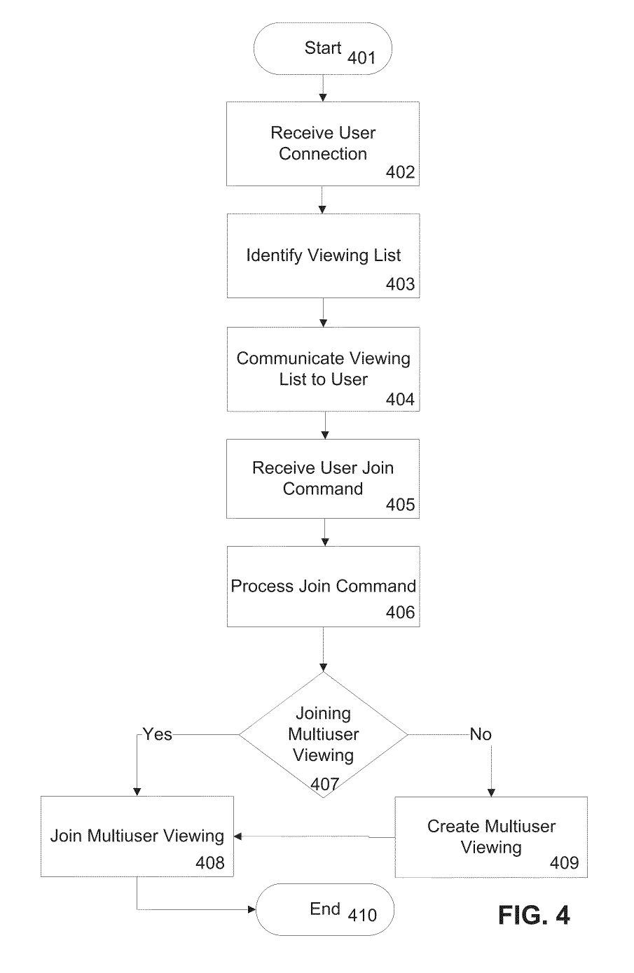

Turning now to FIG. 4, an exemplary method for controlling the process of entering a multiuser viewing mode is shown. At step 401, the process starts with a first user engaging the system to join a multiuser viewing channel. This generally may begin by the first user contacting, via a display device or other computing device or controller, the cloud based servers of the system in order to perform one or more actions with the cloud based system.

At step 402, the system receives a connection request from the first user. In a preferred embodiment, this may include a logon request containing valid login information, such as a username and password combination, although other login means may be utilized as well. In certain instances, where the first user has previously logged on, a session token or other security authentication means may be utilized, allowing for the first user to effectively skip the login process. One of ordinary skill in the art would appreciate that there are numerous methods for handling the login process, and embodiments of the present invention are contemplated for use with any appropriate login method.

At step 403, the system has identified the first user and sets about retrieving a list of other users associated with the first user. In a preferred embodiment, the list, or Viewing List, will be comprised of those secondary users the first user has a connection (e.g., friended on the system, identified by third party social media linked to the system). In this preferred embodiment, the Viewing List will generally be comprised of one or more secondary users who are viewing content and currently active on the system. In certain embodiments, the Viewing List may be limited to those secondary users that wish to partake in multiuser viewing. In still further embodiments, the Viewing List may be limited to those secondary users that are viewing content that the first user also has access to (e.g., first user and secondary user both have access to the same TV channel).

At step 404, the system communicates the Viewing List to the first user. This Viewing List may be displayed on one or more display devices or controlling devices utilized by the first user. An application on one or more of the first user's devices may format and display the Viewing List in an appropriate format and allow the first user to interact and select the secondary user(s) the first user wishes to join in multiuser viewing.

In certain embodiments, two or more display devices and/or controlling devices of the first user may be configured to display the Viewing List. For instance, the first user's smart TV and smartphone may both be linked to the system and configured to receive the Viewing List. In this example, the user could interact with the smartphone in order to provide a selection on the Viewing List, which actions may affect the smart TV.

At step 405, the system receives a command from the first user indicating the first user wishes to join or create a multiuser viewing channel with one or more secondary users on the Viewing List. At step 406, he system processes the join command, identifying the one or more secondary users the first user will be joining for a multiuser viewing channel.

At step 407, the system determines if the secondary user(s) are already in a multiuser viewing channel. If so, the system will likely already have the appropriate connections setup for synchronizing content between the users (e.g., audio channels, video channels, text chat channels, team/option selections). Where the synchronization is already setup, the system moves to step 408, and allows the first user to join the one or more secondary users in the multiuser viewing channel. In certain embodiments, multiuser viewing channels may be locked or secured via password or other security means. Where the multiuser viewing channel is locked, the first user may be prevented from entering. Where the multiuser viewing channel is secured, the first user may be first prompted for entering security credentials prior to being allowed entry into the channel.

If no multiuser viewing channel exists and the secondary user the first user is attempting to join is not already in a multiuser viewing channel, the system may generate a multiuser viewing channel for the first user and secondary user to join (step 409). This may include, but is not limited to, engaging the appropriate synchronization and communication elements, such as audio channels, video channels, text channels, or any combination thereof, are setup and engaged for use by the first user and secondary user. The multiuser viewing channel may also be listed to the friends of the first user and secondary user. The multiuser viewing channel may also generate alerts to other users who had set their preferences to notify them when certain users or certain thresholds (e.g., friends are watching a particular show) for viewing are exceeded.

Once the users have joined the channels, the process terminates at step 410.

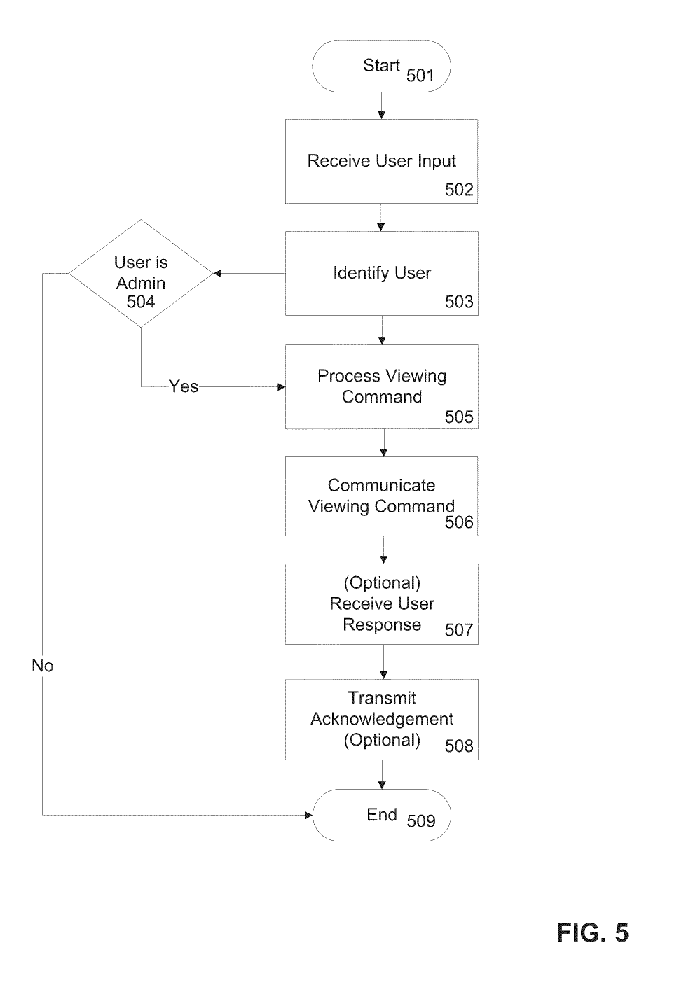

Turning now to FIG. 5, a method for processing viewing commands from users is shown. At step 501, the process starts with a first user engaging the system to issue a command to a multiuser viewing channel. This generally may begin by the first user contacting, via a display device or other computing device or controller, the cloud based servers of the system in order to perform one or more actions with the cloud based system.

At step 502, the system receives a connection request from the first user. In a preferred embodiment, this may include a logon request containing valid login information, such as a username and password combination, although other login means may be utilized as well. In certain instances, where the first user has previously logged on, a session token or other security authentication means may be utilized, allowing for the first user to effectively skip the login process. One of ordinary skill in the art would appreciate that there are numerous methods for handling the login process, and embodiments of the present invention are contemplated for use with any appropriate login method.

At step 503, the system has identified the first user and sets about identifying the multiuser viewing channel the user is part of as well as information about the first user. Optionally, at step 504, the system can verify the user has the appropriate privileges to perform the requested command on the multiuser viewing channel (e.g., is the user an administrator?). If the system determines the user does not have the appropriate privileges, the process terminates at step 509.

Assuming the user is not restricted from making the desired viewing command, the process moves to step 505, whereby the system begins to process the viewing command. Viewing commands may include, but are not limited to, entering team selection requests, entering a quiz question, entering a channel switch command, entering a channel switch vote, entering a content switch command, entering a content switch vote. Team selection requests are described above, and are in relation to each user selecting a team they want to win. Quiz questions are questions presented to users on their individual display screens (or controller devices, especially where multiple users are using a single display screen for viewing the multiuser viewing channel) and may include options for response (i.e., multiple choice). Channel switch commands are commands entered to effect the change of a viewing channel on all display screens attached to the multiuser viewing channel. Channel switch votes are votes initiated by a first user where the first user wants to change the channel (e.g., TV channel) of the multiuser viewing channel and a vote by each viewing user will determine if the channel switch is approved or not. Content switch commands and content switch vote commands are the same as the corresponding channel switch commands, except that the content being switched is not a TV channel. For example, content switching channels could be changing of an audio feed, a streaming video, other streaming content or any combination thereof.

Processing of the viewing command may include, but is not limited to, identifying all recipients of the command, confirmation that the command is possible for each recipient (e.g., some recipient's may not be able to receive or utilize a command—such as a channel switch to a channel a user's display device does not support) and availability of each user (i.e., did anyone disconnect or otherwise become unavailable).

Once processed, the system, at step 506, communicates the command to each of the users in the multiuser viewing channel. In certain embodiments, each user's device will send confirmation back to the system at step 507 (optional). Further, in certain embodiments where confirmation is received from the users, an acknowledgement may be sent to the first user engaging the viewing command at step 508 (optional). At this point, the process terminates at step 509.

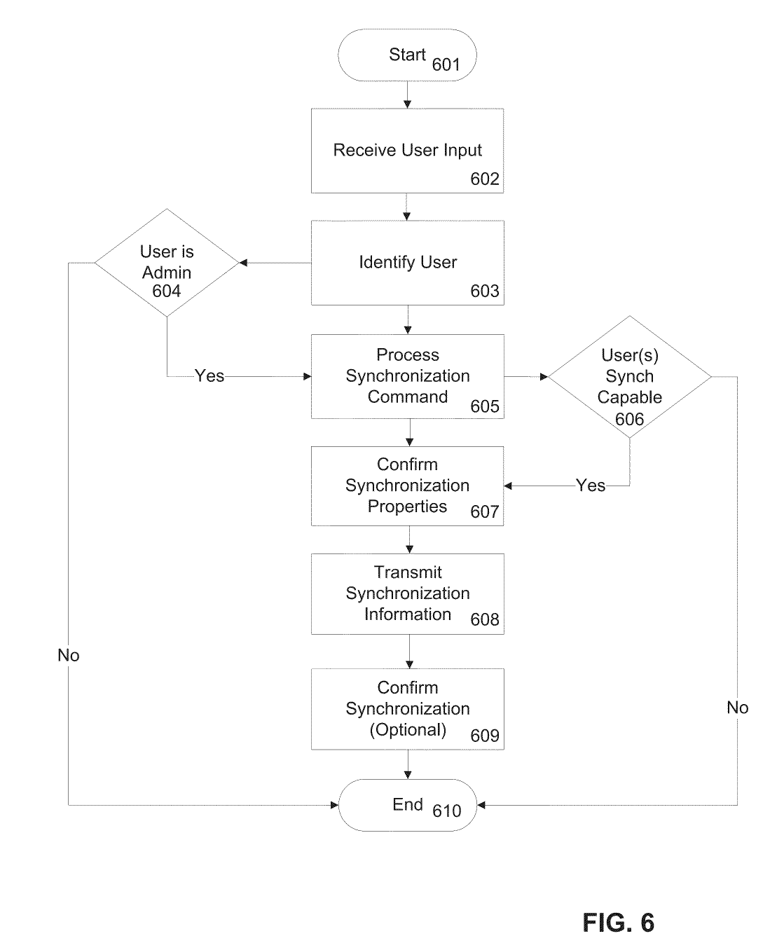

Turning now to FIG. 6, a method for synchronizing multiuser viewing channel content is shown. The synchronization method is similar to the viewing command method, in that the synchronization method may be part of a viewing command (synchronize video content). With the advent and utilization of rewinding, pausing and fast-forwarding live TV and content or other content, synchronization of the actual viewing location amongst the multiple users in a multiuser viewing channel is desirable. The method described herein is a description of how this may be effected.

At step 601, the process starts with a first user engaging the system to issue a synchronization command to a multiuser viewing channel. This generally may begin by the first user contacting, via a display device or other computing device or controller, the cloud based servers of the system in order to perform one or more actions with the cloud based system.

At step 602, the system receives a connection request from the first user. In a preferred embodiment, this may include a logon request containing valid login information, such as a username and password combination, although other login means may be utilized as well. In certain instances, where the first user has previously logged on, a session token or other security authentication means may be utilized, allowing for the first user to effectively skip the login process. One of ordinary skill in the art would appreciate that there are numerous methods for handling the login process, and embodiments of the present invention are contemplated for use with any appropriate login method.

At step 603, the system has identified the first user and sets about identifying the multiuser viewing channel the user is part of as well as information about the first user. Optionally, at step 604, the system can verify the user has the appropriate privileges to perform the requested synchronization command on the multiuser viewing channel (e.g., is the user an administrator?). If the system determines the user does not have the appropriate privileges, the process terminates at step 610.

At step 605, the system begins to process the synchronization command. Processing of the synchronization command may include, but is not limited to, identifying an exact point in the content to move all users connected to the multiuser viewing channel to and also the type of playback to effect (e.g., rewind, pause, play, fast-forward). In certain embodiments, the system may also be configured to check to ensure each user has the capability to engage in the requested synchronization (step 606). If each user cannot effect the synchronization, the system may be configured to simply reject the synchronization so that the users in the multiuser viewing channel are not all at different locations in the content, in which case the process will terminate at 610 with no synchnronization being achieved.

At step 607, the system confirms synchronization properties to be transmitted to each user in the multiuser viewing channel. The synchronization properties may include, but are not limited to, a time offset (based on the time to receive the command as confirmed by one or more of a bandwidth and ping of a user's connection) for the synchronization, a display type, a communications means or any combination thereof. In general, the purpose of the synchronization properties are to confirm that once the synchronization command is transmitted, each user will be at exactly the same spot in the viewing content and with the exact same playback style (e.g., rewind, play, fast-forward, pause). One of ordinary skill in the art would appreciate that there are numerous factors that could impact the synchronization properties and embodiments of the present invention are configured to handle such factors to ensure the synchronization of viewing content and playback style amongst the display devices of the users.

At step 608, the system communicates the synchronization information to each of the users. At this point, the users should all have synchronized content and playback style. Optionally, at step 609, the system may be configured to confirm the synchronization. Confirmation may be one or more of the system confirming each device is at the same viewing location and on the same playback style or confirming to the first user the engagement of synchronization to those users in the multiuser viewing channel. Where the system is confirming that each user successfully “synchronized”, the system may resend an updated synchronization command to any of those users who did not successfully get synchronized. After the synchronization is complete, the process terminates at step 610.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output system (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

According to an embodiment of the present invention, a data store may be comprised of one or more of a database, file storage system, relational data storage system or any other data system or structure configured to store data, preferably in a relational manner. In a preferred embodiment of the present invention, the data store may be a relational database, working in conjunction with a relational database management system (RDBMS) for receiving, processing and storing data. In the preferred embodiment, the data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A computer implemented system for integrating and connecting users viewing content on disparate display devices, the system comprising:
an application software module, comprising computer-executable code stored in non-volatile memory,
a processor,
a memory, and
a communications means,
wherein said application software module, said processor, said memory, and said communications means are operably connected and are configured to:
receive a connection request from a first user via said connection means;
identify said first user;
identify a viewing list associated with said first user, wherein said viewing list comprises a list of one or more multiuser viewing channels attended by one or more secondary users affiliated with said first user;
communicate said viewing list to said first user;
receive a multiuser channel command from said first user; and
process said multiuser channel command, wherein said multiuser channel command effects at least one of said one or more multiuser viewing channels.

2. The computer implemented system of claim 1, wherein said multiuser channel command is a command to join one of said one or more multiuser viewing channels.

3. The computer implemented system of claim 2, wherein said application software module, said processor, said memory, and said communications means are further configured to confirm first user has access privileges to said multiuser viewing channel.

4. The computer implemented system of claim 2, wherein said application software module, said processor, said memory, and said communications means are further configured to transmit to a display element associated with said first user a channel join command, wherein said channel join command allows the display element associated with said first user to join said multiuser viewing channel and view viewing content presented on said multiuser viewing channel.

5. The computer implemented system of claim 1, wherein said multiuser channel command is a command to switch viewing content.

6. The computer implemented system of claim 5, wherein said application software module, said processor, said memory, and said communications means are further configured to transmit to a plurality of display elements associated with said first user and one or more of said one or more secondary users a content switch command, wherein said content switch command allows said plurality of display elements to change displayed content.

7. The computer implemented system of claim 1, wherein said multiuser channel command is a synchronization command, and wherein said application software module, said processor, said memory, and said communications means are further configured to transmit to a plurality of display elements associated with said first user and one or more of said one or more secondary users a synchronization command, wherein said synchronization command effects the synchronization of displayed content across the plurality of display elements such that the content displayed on each element of said plurality of display elements is substantially the same.

8. A computer implemented system, said system comprising:
an application software module, comprising computer-executable code stored in non-volatile memory, configured to:
receive a connection request from a first user via said connection means;
identify said first user;
identify a viewing list associated with said first user, wherein said viewing list comprises a list of one or more multiuser viewing channels attended by one or more secondary users affiliated with said first user;
communicate said viewing list to said first user;
receive a multiuser channel command from said first user; and
process said multiuser channel command, wherein said multiuser channel command effects at least one of said one or more multiuser viewing channels.

9. The computer implemented system of claim 8, wherein said multiuser channel command is a command to join one of said one or more multiuser viewing channels.

10. The computer implemented system of claim 9, wherein said application software module, said processor, said memory, and said communications means are further configured to confirm first user has access privileges to said multiuser viewing channel.

11. The computer implemented system of claim 9, wherein said application software module, said processor, said memory, and said communications means are further configured to transmit to a display element associated with said first user a channel join command, wherein said channel join command allows the display element associated with said first user to join said multiuser viewing channel and view viewing content presented on said multiuser viewing channel.

12. The computer implemented system of claim 8, wherein said multiuser channel command is a command to switch viewing content.

13. The computer implemented system of claim 12, wherein said application software module, said processor, said memory, and said communications means are further configured to transmit to a plurality of display elements associated with said first user and one or more of said one or more secondary users a content switch command, wherein said content switch command allows said plurality of display elements to change displayed content.

14. The computer implemented system of claim 8, wherein said multiuser channel command is a synchronization command, and wherein said application software module, said processor, said memory, and said communications means are further configured to transmit to a plurality of display elements associated with said first user and one or more of said one or more secondary users a synchronization command, wherein said synchronization command effects the synchronization of displayed content across the plurality of display elements such that the content displayed on each element of said plurality of display elements is substantially the same.

15. A computer implemented method for integrating and connecting users viewing content on disparate display devices, the system comprising, the method comprising the steps of:
receiving a connection request from a first user;
identifying said first user;
identifying a viewing list associated with said first user, wherein said viewing list comprises a list of one or more multiuser viewing channels attended by one or more secondary users affiliated with said first user;
communicating said viewing list to said first user;
receiving a multiuser channel command from said first user; and
processing said multiuser channel command, wherein said multiuser channel command effects at least one of said one or more multiuser viewing channels.

16. The computer implemented method of claim 15, wherein said multiuser channel command is a command to join one of said one or more multiuser viewing channels.

17. The computer implemented method of claim 16, further comprises the step of confirming first user has access privileges to said multiuser viewing channel.

18. The computer implemented method of claim 16, further comprising the step of transmitting to a display element associated with said first user a channel join command, wherein said channel join command allows the display element associated with said first user to join said multiuser viewing channel and view viewing content presented on said multiuser viewing channel.

19. The computer implemented method of claim 15, wherein said multiuser channel command is a command to switch viewing content and wherein the method further comprises the step of transmitting to a plurality of display elements associated with said first user and one or more of said one or more secondary users a content switch command, wherein said content switch command allows said plurality of display elements to change displayed content.

20. The computer implemented method of claim 15, wherein said multiuser channel command is a synchronization command, and the method further comprises the step of transmitting to a plurality of display elements associated with said first user and one or more of said one or more secondary users a synchronization command, wherein said synchronization command effects the synchronization of displayed content across the plurality of display elements such that the content displayed on each element of said plurality of display elements is substantially the same.
